(19) United States
(12) Patent Application Publication
(10) Pub. No.: US 2014/0266889 A1
(43) Pub. Date: Sep. 18, 2014

(54) EXTENDING BEAMFORMING CAPABILITY OF A COUPLED VOLTAGE CONTROLLED OSCILLATOR (VCO) ARRAY DURING LOCAL OSCILLATOR (LO) SIGNAL GENERATION THROUGH FREQUENCY MULTIPLICATION

(71) Applicant: Christopher T. Schiller, Redding, CA (US)

(72) Inventor: Christopher T. Schiller, Redding, CA (US)

(21) Appl. No.: 14/215,518

(22) Filed: Mar. 17, 2014

Related U.S. Application Data
(60) Provisional application No. 61/786,511, filed on Mar. 15, 2013.

(51) Int. Cl. H01Q 3/42

(52) U.S. Cl. CPC H01Q 3/42
USPC 342/367; 342/385

(57) ABSTRACT

A method includes separating phase of Local Oscillator (LO) signals generated by individual Voltage Controlled Oscillators (VCOs) of a coupled VCO array through varying voltage levels of voltage control inputs thereto. The method also includes frequency multiplying an output of each individual VCO of the coupled VCO array to increase a range of phase differences between the phase separated LO signals generated by the individual VCOs. Further, the method includes mixing the frequency multiplied outputs of the individual VCOs with signals from antenna elements of an antenna array to introduce differential phase shifts in signal paths coupled to the antenna elements during performing beamforming with the antenna array.

### CLAIM OF PRIORITY

This application is a conversion application of U.S. provisional patent application No. 61/786,511 titled EXTENDING BEAM-FORMING CAPABILITY OF COUPLED VOLTAGE CONTROLLED OSCILLATOR (VCO) ARRAYS DURING LOCAL OSCILLATOR (LO) SIGNAL GENERATION THROUGH FREQUENCY MULTIPLICATION, filed on Mar. 15, 2013.

### FIELD OF TECHNOLOGY

This disclosure generally relates to beamforming and, more specifically, to a method, a circuit and/or a system of extending beamforming capability of a coupled Voltage Controlled Oscillator (VCO) array during Local Oscillator (LO) signal generation through frequency multiplication.

### BACKGROUND

A coupled Voltage Controlled Oscillator (VCO) array may be employed during Local Oscillator (LO) signal generation in a receiver (e.g., a wireless receiver) to generate differential phase shifts. The coupled VCO array may require an external reference signal injected therein to control an operating frequency thereof. Injection locking between the individual VCOs that are part of the coupled VCO array and between the VCOs and the external reference signal may limit the differential phase shift generation to a certain level, beyond which the injection locking breaks down. The phase difference between the VCOs may then become indeterminable.

### SUMMARY

Disclosed are a method, a circuit and/or a system of extending beamforming capability of a coupled Voltage Controlled Oscillator (VCO) array during Local Oscillator (LO) signal generation through frequency multiplication.

In one aspect, a method includes separating phase of LO signals generated by individual VCOs of a coupled VCO array through varying voltage levels of voltage control inputs thereto. The method also includes frequency multiplying an output of each individual VCO of the coupled VCO array to increase a range of phase differences between the phase separated LO signals generated by the individual VCOs. Further, the method includes mixing the frequency multiplied outputs of the individual VCOs with signals from antenna elements of an antenna array to introduce differential phase shifts in signal paths coupled to the antenna elements during performing beamforming with the antenna array.

In another aspect, a beamforming system includes a coupled VCO array including a number of individual VCOs configured to have phase of LO signals generated therethrough separated by varying voltage levels of voltage control inputs thereto. The beamforming system also includes a number of frequency multiplier circuits, each of which is configured to frequency multiply an output of each individual VCO of the coupled VCO array to increase a range of phase differences between the phase separated LO signals generated by the individual VCOs. Further, the beamforming system includes an antenna array including a number of antenna elements, and a number of mixers, each of which is configured to mix the frequency multiplied output of the each individual VCO with a signal from an antenna element of the antenna array to introduce differential phase shifts in signal paths coupled to the antenna elements during performing beamforming with the antenna array.

In yet another aspect, a wireless communication system includes a beamforming system. The beamforming system includes a coupled VCO array including a number of individual VCOs configured to have phase of LO signals generated therethrough separated by varying voltage levels of voltage control inputs thereto. The beamforming system also includes a number of frequency multiplier circuits, each of which is configured to frequency multiply an output of each individual VCO of the coupled VCO array to increase a range of phase differences between the phase separated LO signals generated by the individual VCOs. Further, the beamforming system includes an antenna array including a number of antenna elements, and a number of mixers, each of which is configured to mix the frequency multiplied output of the each individual VCO with a signal from an antenna element of the antenna array to introduce differential phase shifts in signal paths coupled to the antenna elements during performing beamforming with the antenna array.

The wireless communication system also includes a receiver channel configured to receive a combined output of the number of mixers.

Other features will be apparent from the accompanying drawings and from the detailed description that follows.

### BRIEF DESCRIPTION OF THE FIGURES

Example embodiments are illustrated by way of example and not limitation in the figures of the accompanying drawings, in which like references indicate similar elements and in which:

FIG. 1 is a schematic view of a Radio Frequency (RF)-scanned beamforming system.

FIG. 2 is a schematic view of a Local Oscillator (LO) scanned beamforming system.

FIG. 3 is a schematic view of a coupled Voltage Controlled Oscillator (VCO) array of the LO scanned beamforming system of FIG. 2.

FIG. 4 is a schematic view of a coupled VCO array of the LO scanned beamforming system of FIG. 2 incorporating frequency multiplication therein, according to one or more embodiments.

FIG. 5 is a process flow diagram detailing operations involved in extending beamforming capability of the coupled VCO array of FIG. 4 during LO signal generation through frequency multiplication, according to one or more embodiments.

Other features of the present embodiments will be apparent from the accompanying drawings and from the disclosure that follows.

### DETAILED DESCRIPTION

Example embodiments, as described below, may be used to provide a method, a circuit and/or a system of extending beamforming capability of a coupled Voltage Controlled Oscillator (VCO) array during Local Oscillator (LO) signal generation through frequency multiplication. Although the present embodiments have been described with reference to specific example embodiments, it will be evident that various modifications and changes may be made to these embodiments without departing from the broader spirit and scope of the various embodiments.

FIG. 1 shows a Radio Frequency (RF)-scanned beamforming system 100, according to one or more embodiments. Beamforming may be a processing technique for electronically pointing fixed arrays of antenna apertures during wireless transmission and/or reception. For example, beamforming may be used to create a focused antenna beam by shifting a signal in time or in phase to provide gain of the signal in a desired direction and to attenuate the signal in other directions. Here, the arrays may be one-dimensional, two-dimensional, or three-dimensional, and the electronic pointing of an antenna array may be performed for transmission and/or reception of signals. Beamforming may be utilized to direct the energy of a signal transmitted from an antenna array and/or to concentrate the energy of a received signal into an antenna array. Electronically pointing an antenna array may be faster and more flexible than physically pointing a directional antenna.

By directing the energy from and/or concentrating the energy incoming to an antenna array, higher efficiency may be achieved when compared to implementations utilizing a standard antenna. This may result in a capability to transmit and/or receive signals correspondingly to and/or from more distant receiving and/or transmitting radios.

Beamforming may be commonly accomplished by introducing differential phase shifts in the signal paths connected to each of the antenna apertures (antenna elements). One conventional technique, shown in FIG. 1 (e.g., an example beamforming system such as RF-scanned beamforming system 100), may introduce the required phase shifts in the signal paths by using an RF-scanned array (e.g., including antenna array 106), in which explicit phase shifters 104 are connected directly in series with the signal paths (e.g., signal paths from antenna array 106). As shown in FIG. 2 (another example beamforming system), another conventional technique may introduce the required phase shifts in the signal paths by using a Local Oscillator (LO)-scanned array, in which LO signals 102 with differential phases are generated and the differential phase LO signals 102 input to mixers 111 (see also FIG. 1) located in the signal paths (e.g., signal paths coupled to antenna array 106).

Antenna array 106 may be utilized in beam-steering or directing and/or focusing of transmitted/received signals. By directing the energy from and/or concentrating the energy incoming thereto, a higher efficiency may be achieved compared to a standard antenna implementation. This may result in the capability to transmit and/or receive signals corresponding to and/or from more distant receiving or transmitting radios, as discussed above.

A voltage controlled oscillator (VCO) 101 (see FIGS. 1-4) may be an electronic oscillator configured to vary oscillation frequency thereof based on a voltage input. FIGS. 1-4 serve to describe the receiver (e.g., wireless receiver) context in which exemplary embodiments discussed herein may be practiced. The function of VCO 101 in LO signal generation (e.g., LO signal(s) 102 of FIGS. 1-2) as applied to receivers is well known to one of ordinary skill in the art. In order to generate differential phase LO signals, a coupled VCO array may be utilized. FIG. 2 shows an LO scanned beamforming system 200 including a coupled VCO array 250. Here, coupled VCO array 250 may include two or more VCOs 101 mutually injection locked to each other. Injection locking may be the state in which the two or more VCOs 101 exchange oscillatory energy sufficient enough to lock to a same frequency. Injection locking may be accomplished based on coupling VCOs 101 together through a bidirectional coupling circuit (e.g., resistor 103; other bidirectional circuits may also be used instead).

When a single VCO 101 is used, voltage control is utilized to vary the frequency thereof, as discussed above. In coupled VCO array 250, once the two or more VCOs 101 are injection locked to each other, the voltage control inputs (e.g., control inputs 306 shown in FIG. 3) to the two or more VCOs 101 may still be utilized to vary the frequency of coupled VCO array 250 provided that the voltage control inputs have the same voltage levels and are varied in the same manner. If the voltage levels are different, the phase of the signals generated by the individual VCOs 101 may be separated. The aforementioned phase separation between the LO signals generated by the individual VCOs in coupled VCO array 250 may be utilized to perform beamforming when the phase-separated LO signals (e.g., LO signals 102) are mixed (e.g., through mixers 111) with transmit or receive signals to or from antenna array 106. The outputs of mixers 111 may be combined at a combiner 112 (e.g., a combiner circuit).

FIG. 1 also shows beamformer 150; said beamformer 150 is shown as including a switch matrix 113 and combiner 112; switch matrix 113 may be understood to be circuitry associated with routing signals (e.g., RF signals) between multiple inputs and outputs; combiner 112, obviously, may combine the multiple outputs of switch matrix 113. Here, the outputs of phase shifters 104 may serve as the multiple inputs to switch matrix 113.

In FIG. 2, voltage control inputs of coupled VCO array 250 may be utilized exclusively for achieving phase separation between VCOs 101. Therefore, the voltage control inputs may be no longer available to be used for controlling the operating frequency of coupled VCO array 250. As the aforementioned operating frequency control is essential to a beamforming system, a separate reference signal may be injected into coupled VCO array 250. FIG. 3 shows coupled VCO array 250 with a reference input signal 305 thereto (e.g., shown as being coupled to VCOs 101 through unidirectional coupling circuit 304). The frequency control of reference input signal 305 may be accomplished through a system independent of coupled VCO array 250. The mechanism for injecting reference input signal 305 may also be based on injection locking. Thus, VCOs 101 of FIG. 3 may not only be mutually injection locked to each other, but also injection locked to reference input signal 305. As discussed above, control inputs 306 may be utilized to vary the frequency of coupled VCO array 250.

Coupled VCO array 250 may only generate differential phase shifts up to a certain level. Beyond this level, mutual injection locking may break down, and phase differences between VCOs 101 may be indeterminable. Thus, the range of possible LO phase differences generated through coupled VCO array 250 may be limited.

It will be appreciated that concepts disclosed herein may also be applied to two-dimensional or three-dimensional arrays of VCOs 101, in addition to one-dimensional arrays thereof. FIG. 4 shows frequency multiplication incorporation in an improved coupled VCO array 400, according to one or more embodiments. In one or more embodiments, coupled VCO array 400 may be analogous to coupled VCO array 250; elements of coupled VCO array 400 are numbered the same way in FIG. 4 as elements of coupled VCO array 250. In one or more embodiments, the range of possible LO phase differences of a differential phase LO system may be increased by frequency multiplying each output of a VCO 101 of coupled VCO array 400. FIG. 4 shows a frequency multiplier 402 placed in the individual signal path between a VCO 101 and a mixer (e.g., mixer 111).

In one or more embodiments, the factor by which the frequency is multiplied may also be the factor by which the phase difference range is increased (relative to the period of the LO signal). For example, doubling the frequency of the phased LO signals may also double the phase difference therebetween. If M is the frequency multiplication factor (e.g., M=2 indicates frequency doubling), and P the phase difference between two LO signals (in degrees), then M×P is the resulting phase difference after frequency multiplication. Circuit configurations of frequency multiplier 402 are well known to one skilled in the art. The choice of frequency multiplier architecture may not influence the range of phase differences obtained through the teachings of the exemplary embodiments discussed herein.

In one or more embodiments, by increasing the range of phase differences, including frequency multipliers 402 in a beamforming LO generation system (e.g., LO scanned beamforming system 200) may improve the beamforming performance of the system; the system may also be improved from a power, cost, and flexibility point of view. In one or more embodiments, wider beamforming angles may be used to aid performance and flexibility of design and/or implementation. Additionally, in one or more embodiments, when using frequency multipliers 402, it may be possible to design coupled VCO array 400 at lower frequencies compared to coupled VCO array 250, resulting in lower power, lower cost, and an easier, less-risky design. It should be noted that a length of coupled VCO array 400 (e.g., a number of VCOs 101 therein) may be extrapolated as shown in FIG. 4 based on a requirement of the beamforming discussed above. Further, it should be noted that a combined output of mixers 111 in FIG. 2 may be input to a channel of a wireless receiver incorporating the beamforming discussed above.

FIG. 5 shows a process flow diagram detailing operations involved in extending beamforming capability of coupled VCO array 400 during LO signal generation through frequency multiplication, according to one or more embodiments. In one or more embodiments, operation 502 may involve separating phase of LO signals (e.g., LO signals 102) generated by individual VCOS 101 of coupled VCO array 400 through varying voltage levels of voltage control inputs (e.g., control inputs 306) thereto. In one or more embodiments, operation 504 may involve frequency multiplying an output of each individual VCO 101 of coupled VCO array 400 to increase a range of phase differences between the phase separated LO signals generated by the individual VCOs 101. In one or more embodiments, operation 506 may then involve mixing the frequency multiplied outputs of the individual VCOs 101 with signals from antenna elements of antenna array 106 to introduce differential phase shifts in signal paths coupled to the antenna elements during performing beamforming with antenna array 106.

Although the present embodiments have been described with reference to specific example embodiments, it will be evident that various modifications and changes may be made to these embodiments without departing from the broader spirit and scope of the various embodiments. Accordingly, the specification and drawings are to be regarded in an illustrative rather than a restrictive sense.

What is claimed is:

1. A method comprising:
separating phase of Local Oscillator (LO) signals generated by individual Voltage Controlled Oscillators (VCOs) of a coupled VCO array through varying voltage levels of voltage control inputs thereto;
frequency multiplying an output of each individual VCO of the coupled VCO array to increase a range of phase differences between the phase separated LO signals generated by the individual VCOs; and
mixing the frequency multiplied outputs of the individual VCOs with signals from antenna elements of an antenna array to introduce differential phase shifts in signal paths coupled to the antenna elements during performing beamforming with the antenna array.

2. The method of claim 1, further comprising injection locking two or more VCOs of the coupled VCO array to each other.

3. The method of claim 2, comprising coupling a VCO of the coupled VCO array to another VCO thereof through a bidirectional coupling circuit.

4. The method of claim 1, comprising providing one of: a one-dimensional, a two-dimensional and a three-dimensional VCO array as the coupled VCO array.

5. The method of claim 1, further comprising combining outputs of the mixing at a combiner circuit as part of the beamforming.

6. The method of claim 1, further comprising extrapolating a length of the coupled VCO array based on a requirement of the beamforming.

7. The method of claim 1, further comprising designing, based on the frequency multiplication, the coupled VCO array at a frequency lower than a frequency of the coupled VCO array without the frequency multiplication.

8. A beamforming system comprising:
a coupled VCO array comprising a plurality of individual VCOs configured to have phase of LO signals generated therethrough separated by varying voltage levels of voltage control inputs thereto;
a plurality of frequency multiplier circuits, each of which is configured to frequency multiply an output of each individual VCO of the coupled VCO array to increase a range of phase differences between the phase separated LO signals generated by the individual VCOs;
an antenna array comprising a plurality of antenna elements; and
a plurality of mixers, each of which is configured to mix the frequency multiplied output of the each individual VCO with a signal from an antenna element of the antenna array to introduce differential phase shifts in signal paths coupled to the antenna elements during performing beamforming with the antenna array.

9. The beamforming system of claim 8, wherein two or more VCOs of the coupled VCO array are injection locked to each other.

10. The beamforming system of claim 9, further comprising a plurality of bidirectional coupling circuits, each of which is configured to couple a VCO of the coupled VCO array to another VCO thereof.

11. The beamforming system of claim 8, wherein the coupled VCO array is one of: a one-dimensional, a two-dimensional and a three-dimensional VCO array.

12. The beamforming system of claim 8, further comprising a combiner circuit to combine outputs of the plurality of mixers as part of the beamforming.

13. The beamforming system of claim 8, wherein a length of the coupled VCO array is configured to be extrapolated based on a requirement of the beamforming.

14. The beamforming system of claim 8, wherein, based on the plurality of frequency multiplier circuits, the coupled VCO array is configured to be designed at a frequency lower than a frequency of the coupled VCO array without the plurality of frequency multiplier circuits.

15. A wireless communication system comprising:
a beamforming system comprising:
a coupled VCO array comprising a plurality of individual VCOs configured to have phase of LO signals generated therethrough separated by varying voltage levels of voltage control inputs thereto;
a plurality of frequency multiplier circuits, each of which is configured to frequency multiply an output of each individual VCO of the coupled VCO array to increase a range of phase differences between the phase separated LO signals generated by the individual VCOs;
an antenna array comprising a plurality of antenna elements; and
a plurality of mixers, each of which is configured to mix the frequency multiplied output of the each individual VCO with a signal from an antenna element of the antenna array to introduce differential phase shifts in signal paths coupled to the antenna elements during performing beamforming with the antenna array; and
a receiver channel configured to receive a combined output of the plurality of mixers.

16. The wireless communication system of claim 15, wherein two or more VCOs of the coupled VCO array of the beamforming system are injection locked to each other.

17. The wireless communication system of claim 16, wherein the beamforming system further comprises a plurality of bidirectional coupling circuits, each of which is configured to couple a VCO of the coupled VCO array to another VCO thereof.

18. The wireless communication system of claim 15, wherein the coupled VCO array of the beamforming system is one of: a one-dimensional, a two-dimensional and a three-dimensional VCO array.

19. The wireless communication system of claim 15, wherein a length of the coupled VCO array of the beamforming system is configured to be extrapolated based on a requirement of the beamforming.

20. The wireless communication system of claim 15, wherein, based on the plurality of frequency multiplier circuits of the beamforming system, the coupled VCO array of the beamforming system is configured to be designed at a frequency lower than a frequency of the coupled VCO array without the plurality of frequency multiplier circuits.
